(19) United States
(12) Patent Application Publication
(10) Pub. No.: US 2016/0210559 A1
(43) Pub. Date: Jul. 21, 2016

(54) SYSTEM AND METHOD TO MONITOR, VISUALIZE, AND PREDICT DISEASES

(71) Applicant: Oxford Epidemiology Services, LLC, Washington, DC (US)

(72) Inventor: Rachel Jean-Baptiste, Washington, DC (US)

(21) Appl. No.: 15/060,555

(22) Filed: Mar. 3, 2016

Related U.S. Application Data
(60) Provisional application No. 62/288,986, filed on Jan. 29, 2016.

(51) Int. Cl. G06N 7/00; G06N 5/04

(52) U.S. Cl. CPC G06N 7/005; G06N 5/048

(57) ABSTRACT

A system and method to monitor, visualize, and predict the progression or recession of symptoms or diseases is disclosed herein. The system includes a control server that creates and disperses surveys that are tailored to target a particular symptom or disease, such as Ebola. Various users operating a plurality of computing devices in the field, such as in a particular country, may answer the questions for every patient, and then transmit the data in real-time to a database associated with and accessible by the control server. The control server may perform various calculations including prediction analysis on the received data in order to determine the prevalence and possible spread of the disease. Based on the analysis by the control server, decision-makers in Non-Governmental Organizations may make accurate and effective decisions in a more time effective and cost-efficient basis, and ultimately save lives.

### CROSS-REFERENCE TO RELATED APPLICATIONS

This non-provisional application claims the benefit of Provisional Application No. 62/288,986 filed on Jan. 29, 2016, the entire disclosure of which is hereby incorporated herein by reference.

### BACKGROUND

The outbreak of a disease can occur without the slightest warning and instantly turn into an epidemic, endemic, or pandemic. When these outbreaks occur, it is useful for decision-makers, such as decision-makers within Government, Non-Governmental Organizations, and the private sector to immediately know the status of the outbreak, such as the outbreaks geographic location(s), how quickly the disease is spreading, where the disease originated, etc. During an outbreak, the information and data about the subject population may not be fully accurate or there may be gaps of missing data. In addition, each data gatherer on the ground, that is, at the geographic site of the outbreak, may collect different information about patients instead of collecting a steady and consistent series of information about each patient, which also makes the overall processing of data difficult.

In addition, when data is available about the subject population, the data may that is transmitted may come from a variety of sources and computing devices. Each source and computing device may transmit the data in different formats, thereby creating difficulty in analyzing, processing, and potentially even using the data. During an outbreak or before the outbreak occurs, an established system may be useful in identifying a potential outbreak before it even occurs.

### SUMMARY

A system and method that continuously receives data from a plurality of computing devices and processes and visualizes the data in real-time is disclosed. The data may be based on a survey created by an administrator, or automated, wherein the survey is tailored to discover particular symptoms associated with a particular disease or sickness. Multiple users operating computing devices may answer the questions in the survey for each patient the user encounters. From there, the data may be sent to a control server which re-formats the data into one readable format for the control server, so that all information received from the plurality of computing devices is accounted for. The control server may then perform various processes on the received data, such as predictive analyses on the potential progression or regression of symptoms or diseases based on the data.

The system according to the above includes memory and one or more computing devices operatively coupled to the memory, wherein the one or more processors are configured to: continuously receive, from a plurality of computing devices, symptom information of a population, wherein the symptom information received from each of the plurality of computing devices is in a different data format; reformat the received symptom information into a single data format; display the reformatted symptom information in real-time into a graphic; continuously update the displayed graphic, in real-time, with newly received symptom information of the population; and predict future patterns on the displayed graphic based on the newly received transmitted information and the populous information, wherein the prediction of future patterns includes predicting future symptoms or diseases in a geographic region.

As a further example, at least two of the plurality of computing devices are in different geographical regions. As another example, the one or more processors are configured to create a link, wherein the link is associated with a unique survey; and send the link to at least one computing device of the plurality of computing devices, wherein selection of the link directs the at least one computing device of the plurality of computing devices to the unique survey. In that example, the one or more processors are further configured to send, at the at least one computing device, the unique survey, wherein the unique survey is completed; and receive, from the at least one computing device, the completed unique survey. In another example, the continuously updated symptom information is continuously updated on the displayed graphic, the continuously updated displayed graphic illustrating a speed of spread of a disease or symptom. In another example, the one or more processors are further configured to display customizable segments of time of the displayed graphic, wherein the customizable segments of time illustrate the continuously updated symptom information being updated in that particular segment of time.

As another embodiment, a method is disclosed. The method includes continuously receiving, from a plurality of computing devices, symptom information of a population, wherein the symptom information received from each of the plurality of computing devices is in a different data format; reformatting the received symptom information into a single data format; displaying the reformatted symptom information in real-time into a graphic; continuously updating the displayed graphic, in real-time, with newly received symptom information of the population; and predicting future patterns on the displayed graphic based on the newly received transmitted information and the populous information, wherein the prediction of future patterns includes predicting future symptoms or diseases in a geographic region.

As another example of the method, at least two of the plurality of computing devices are in different geological regions. As a further example, the method includes creating, using the one or more processors, a link, wherein the link is associated with a unique survey; and sending, using the one or more processors, the link to at least one computing device of the plurality of computing devices, wherein selection of the link directs the at least one computing device of the plurality of computing devices to the unique survey. In that example, the method further includes sending, at the at least one computing device using the one or more computing device processors, the unique survey, wherein the unique survey is completed; and receiving, from the at least one computing device using the one or more computing device processors, the completed unique survey. In another example, the continuously updated symptom information is continuously updated on the displayed graphic, the continuously updated displayed graphic illustrating a speed of spread of a disease or symptom. As a further example, the method includes displaying customizable segments of time of the displayed graphic, wherein the customizable segments of time illustrate the continuously updated symptom information being updated in that particular segment of time.

As a further embodiment, a system is disclosed that includes a first computing device, wherein the first computing device includes: a first memory; and one or more first computing device processors operatively coupled to the first memory, wherein the one or more first computing device processors are configured to: input information about a population of people; and transmit the information to a second computing device; and the system further includes the second computing device, wherein the second computing device includes: a second memory; and one or more second computing device processors operatively coupled to the second memory, wherein the one or more second computing device processors are configured to: receive in real-time, from the first computing device, the transmitted information; combine the transmitted information with a plurality of transmitted information from a plurality of computing devices to create a populous information; display the populous information in real-time into a graphic; and continuously update the graphic, in real-time, with newly received transmitted information.

As a further example of that system, the one or more second computing device processors are further configured to predict future patterns on the graphic based on the newly received transmitted information and the populous information, wherein the prediction of future patterns includes predicting future spread or outbreak of a disease.

### BRIEF DESCRIPTION OF THE DRAWINGS

FIG. 1 represents an overview of an exemplary system in accordance with aspects of the disclosure.

FIG. 2 is illustrates a further example of the system of FIG. 1 in accordance with aspects of the disclosure.

FIG. 3 depicts various links being available to computing devices in accordance with aspects of the disclosure.

FIG. 4 illustrates a survey that is associated with one of the links in accordance with aspects of the disclosure.

FIG. 5 illustrates the computing devices transmitting data to a control server in accordance with aspects of the disclosure.

FIG. 6 depicts the control server processing the transmitted data in accordance with aspects of the disclosure.

FIGS. 7A-B depict a visual representation and development of symptom or disease information in accordance with aspects of the disclosure.

FIG. 8 is a flowchart of one embodiment of the present disclosure.

### DETAILED DESCRIPTION

The aspects, features and advantages of the present disclosure will be appreciated when considered with reference to the following description of preferred embodiments and accompanying figures. The following description does not limit the disclosure; rather, the scope is defined by the appended claims and equivalents. While certain processes in accordance with example embodiments are shown in the figures as occurring in a linear fashion, this is not a requirement unless expressly stated herein. Different processes may be performed in a different order or concurrently.

The present disclosure describes a system and a method that, in real-time, monitors, processes, and visualizes symptom and/or disease information about a population of people. For example, a survey may be generated by a control server that associates the survey with a particular link. From here, the link may be dispersed or otherwise made available to a plurality of computing devices and users. Users that have a particular computing device of the plurality computing devices may select the link, thereby being able to access and use the survey associated therewith. The users may then collect information from individual people and fill out the survey associated with the link accordingly. Once the information or data about each individual person is selected and the survey is completed, the survey may be transmitted to the control server for processing. The control server may first re-format all of the received data into a single readable and usable format. The control server will then continuously monitor the data, transform the data into a visual representation, such as a graph or indication on a map, and predict subsequent events or developments on the subject population of people based on the received data and information.

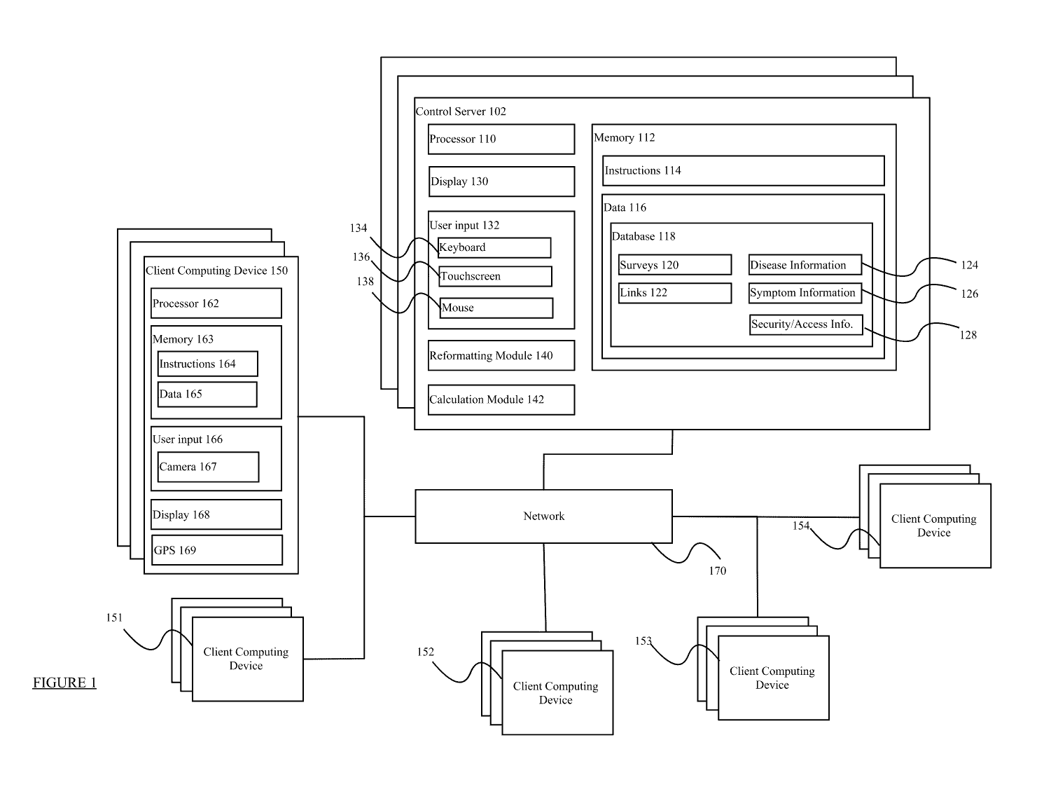

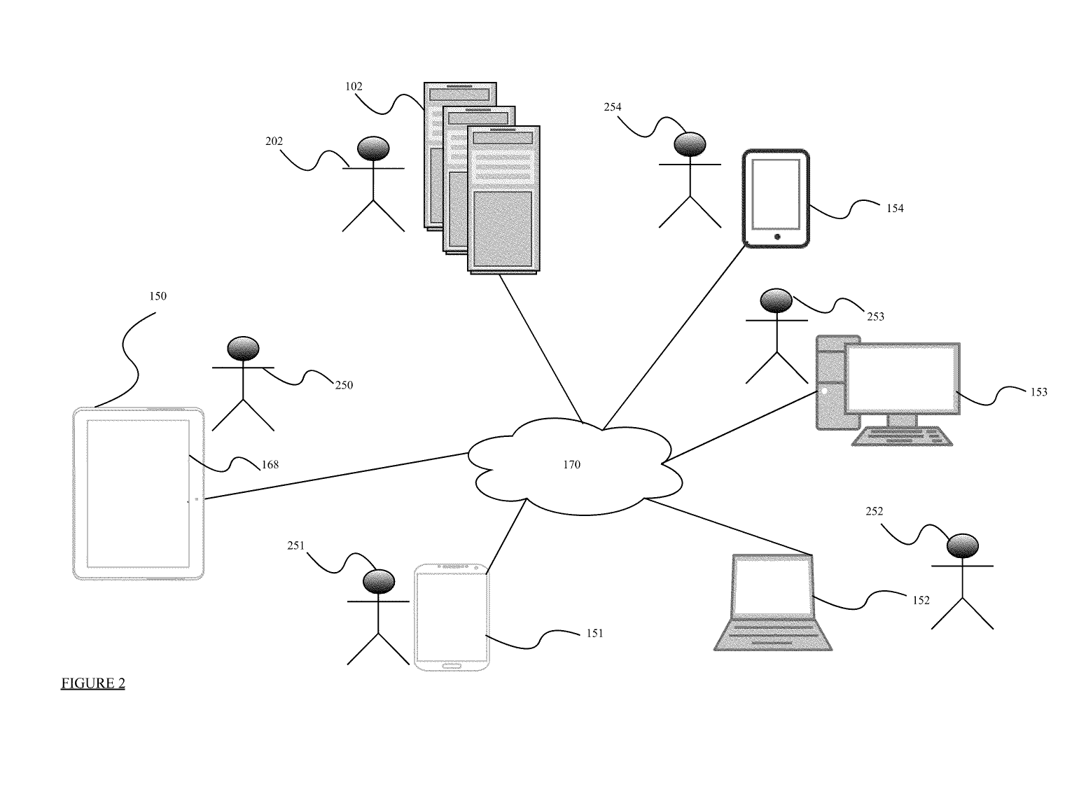

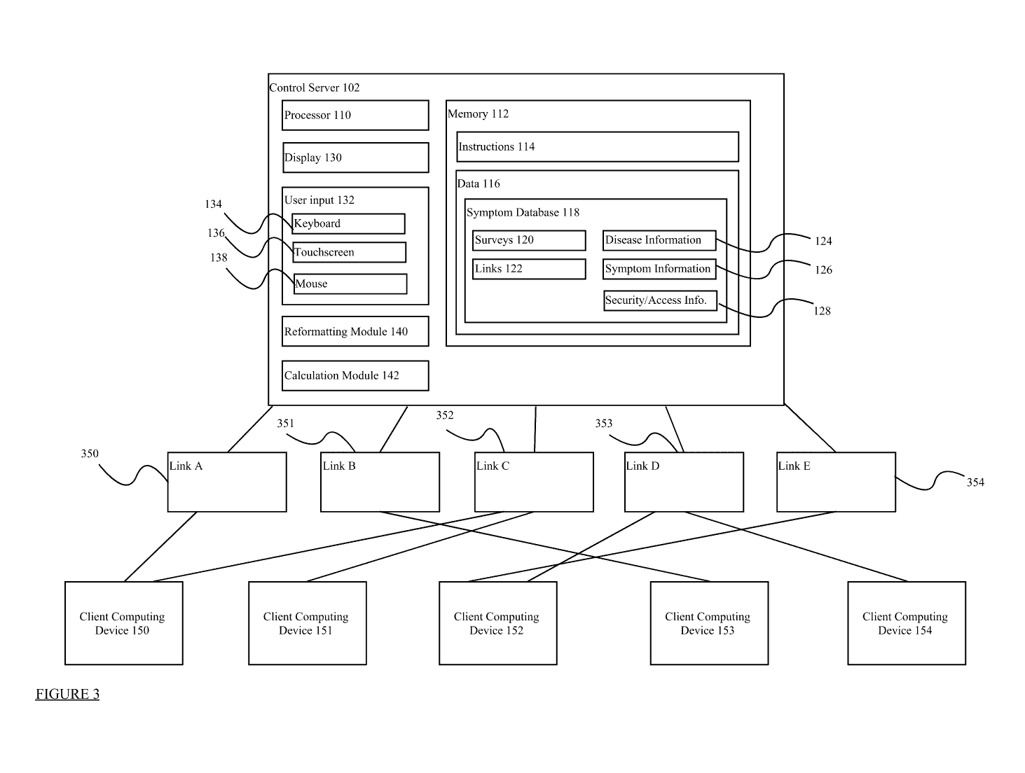

FIGS. 1 and 2 include example systems in which the features described above may be implemented. It should not be considered as limiting the scope of the disclosure or usefulness of the features described herein. In this example, the system can include control server 102 and computing devices 150-154. Control server 102 and each of the computing devices 150-154 can contain one or more processors, memory and other components typically present in computing devices.

Memory 112 can include data 116 that can be retrieved, manipulated or stored by processor 110. Memory 112 can be of any non-transitory type capable of storing information accessible by processor 110, such as a hard-drive, memory card, ROM, RAM, DVD, CD-ROM, write-capable, and read-only memories.

Instructions 114 can be any set of instructions to be executed directly, such as machine code, or indirectly, such as scripts, by processor 110. In that regard, the terms “instructions,” “application,” “steps” and “programs” can be used interchangeably herein. Instructions 114 can be stored in object code format for direct processing by the processor, or in any other computing device language including scripts or collections of independent source code modules that are interpreted on demand or compiled in advance. Functions, methods and routines of the instructions are explained in more detail below.

Data 116 can be retrieved, stored or modified by processor 110 in accordance with the instructions 114. For instance, although the subject matter described herein is not limited by any particular data structure, data 116 can be stored in computer registers, in a relational database as a table having many different fields and records, or XML documents. The data can also be formatted in any computing device-readable format such as, but not limited to, binary values, ASCII or Unicode. Moreover, data 116 can comprise any information sufficient to identify the relevant information, such as numbers, descriptive text, proprietary codes, pointers, references to data stored in other memories such as at other network locations, or information that is used by a function to calculate the relevant data.

Referring to FIGS. 1 and 2, data 116 can include database 118 to store various information. For example, information stored in database 118 includes surveys 120, links 122, various disease information 124, symptom information 126, and security or access information 128, all of which will be discussed in more detail below. Although database 118 is illustrated as being within the same housing as control server 102, database 118 may be remote from control server 102. For instance, database 118 and control server 102 may be connected over network 170. Network 170 may be a Personal Area Network, Local Area Network, Wide Area Network, or the Internet. Control server 102 can have the capability to read, write, and access data on database 118. Furthermore, database 118, control server 102, or both may operate using expandable cloud storage capabilities, such as using an Amazon Web Services® proprietary system. In this regard, whether control server 102 or simply database 118 is stored in cloud-based storage, a user may use any computing device, such as a laptop, personal computer, Smartphone, tablet, etc. to access and manipulate the contents in database 118 and control server 102.

Processor 110 can be any conventional processor, such as a commercially available CPU. Alternatively, processor 110 can be a dedicated component such as an ASIC or other hardware-based processor. Although not necessary, control server 102 may include specialized hardware components to perform specific computing processes, such as decoding video, matching image frames with images, distorting videos, encoding distorted videos, etc. faster or more efficiently.

Control server 102 can include display 130 (e.g., a monitor having a screen, a touch-screen, a projector, a television, or other device that is operable to display information), and user input 132. User input 132 may include, for example, keyboard 134, touchscreen 136, and mouse 138. Other input devices are also possible, such as a microphone. In this regard, control server may include only one or a plurality of the various input devices. Control server 102 may also include various modules and partitions that are stored in memory 112 and accessible by processor 110 to perform certain functions as described in more detail below. As one example, reformatting module 140 and calculation module 142 perform particular functions and are contained on control server 102.

Computing device 150 may also include a processor 162, memory 163, instructions 164, data 165, user input 166, and display 168, all of which may perform similarly as discussed above with respect to the processor 110, memory 112, instructions 114, data 116, user input 132, and display 130 of control server 102, respectively. Furthermore, although not shown client computing device 150 may also include input devices such as a keyboard, touchscreen, a mouse, or any combination thereof. In addition, as illustrated in FIG. 1 client computing device 150 includes camera 167 as an input device. Camera 167 may be used to capture images of a particular patient or symptom, such as, by way of example only, to capture an identification photograph of a patient or to capture a photograph of a rash on an epidermis of the patient. In addition, client computing device 150 may also include a Global Positioning System (“GPS”) device 169 or other geo-location identifying systems in order to identify the location of computing device 150. For example, the positioning component may include a GPS receiver to determine the particular device's latitude, longitude and/or altitude position. The location of the client computing devices may include an absolute geographical location, such as latitude, longitude, and altitude as well as relative location information, such as relative to a particular device or object. Although not shown, client computing devices 151-154 also include a processor, memory, a display, various input devices, GPS etc. and overall may be constructed and configured to operate similarly to client computing device 150 as discussed above.

Although FIG. 1 functionally illustrates processor 110, memory 112, and other elements of the control server 102 as being within the same block, processors, memory, control server, displays, etc. can actually comprise multiple processors, memories, control servers, displays, etc. that may or may not be stored within the same physical housing. For example, memory 112 can be a hard drive or other storage media located in a housing different from that of control server 102. Accordingly, references to a processor, memory, computer, control server, etc. will be understood to include references to a collection of processors, memories, computers, control servers, etc. that may or may not operate in parallel. For example, control server 102 may include a single server computing device or a load-balanced server farm. And although some functions described below are indicated as taking place on a single computing device having a single processor, various aspects of the subject matter described herein can be implemented by a plurality of computing devices, for example, communicating information over network 170.

Similarly, processor 162 and memory 163 of client computing device 150 may be contained within the same housing or operate remotely from each other, and may include a plurality of components therein. For instance, processor 162, memory 163, and other components of client computing device 150 may be a plurality of processors, memories, etc., and should not be restricted to a single or particular type of processor or memory. Further, information collected on client computing device 150 may store temporarily in memory 163 (such as in Random Access Memory or on an internal hard drive) and be transmitted over network 170 to a remote database (not shown) in a hard drive, or alternatively transmitted directly to database 118 of control server 102. If, for example, data is stored in a distinct database remote from client computing device 150 and control server 102, the data may subsequently be accessible by control server 102. Client computing device 151-154 are also configured similarly to client computing device 150.

Although client computing devices 150-154 may each comprise a full-sized personal computing device, they may alternatively comprise mobile computing devices capable of wirelessly exchanging data with each other or control server 102, such as via network 170. FIG. 2 illustrates exemplary computing devices of control server 102 and client computing devices 150-154. By way of example only, client computing devices 150-154 may be a mobile phone (e.g., Smartphone) or a device such as a wireless-enabled PDA, a tablet, a laptop, head-mountable device, Smart watch, or a netbook that is capable of obtaining and transmitting information via the Internet.

Control server 102 and computing devices 150-154 can be at nodes of network 170 and capable of directly and indirectly communicating with other nodes of network 170. Although only a few computing devices are depicted in FIGS. 1-2, it should be appreciated that a typical system can include a large number of connected computing devices, with each different computing device being at a different node of the network 170. The network 170 and intervening nodes described herein can be interconnected using various protocols and systems, such that the network can be part of the Internet, World Wide Web, specific intranets, Wide Area Networks, or Local Area Networks. Network 170 can utilize standard communications protocols, such as Ethernet, WiFi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, one or more computing devices 150-154 may include a web server that is capable of communicating with control server 102 as well as other computing devices 150-154 via network 170. For example, user 202 of control server 102 may use network 170 to transmit and present information to user 250 on a display of computing device 150. Similarly, users 250-254 may use client computing devices 150-154 to upload and transmit information to control server 102 that user 202 may view on display 130.

User 202 may create a survey or otherwise a series of questions for a population of people using control server 102. The survey may be saved on database 118 and accessible by control server 102 and client computing devices 150-154. This survey may be prompted as a result of indications of a particular disease outbreak in a given geographical area. In this regard, if the potential disease outbreak is, for instance, Ebola, then user 202 can tailor the survey to questions concerning known symptoms of Ebola. By doing so, user 202 can establish a series of questions for a population of people to determine if the particular population of people contain symptoms typically associated with Ebola. As an alternative, user 202 may create a survey as a prophylactic attempt to monitor a particular area for the potential outbreak of one or more diseases, such as the common cold or flu.

In addition, an unlimited number and type of data collection tools can be created to collect quantitative (number-type data) and qualitative (text) data from health facilities, schools, or any other population groups to be used in the social sector (international development, public health, public schools, or other public services in the United States or abroad). For a healthcare example, an electronic medical record may be developed to collect patient level data, or a tool that collects data about a group of patients (e.g. patients with TB, or HIV, or malaria), or about the management of a health system (number of workers, number of facilities, patient outcomes (births, deaths, cures, etc.). As another example, school information may be collected, in which data on individual student performance, or the management of student bodies (e.g., student attendance, gender, percentage or number of students graduating, etc.), or the management of the school overall. Other examples include public polls, exit interviews, client satisfaction surveys, election monitoring, vital statistics (birth and death rates), etc. The particular data collected may depend on the overall purpose of the implemented system. In this regard, although the disclosure herein references monitoring diseases, such as Ebola, the present disclosure should not be restricted thereto.

User 202 may have control over who is given access to various information created by control server 102, such as surveys stored in database 118. Accessibility criteria may be stored and regulated by security and access information 128 data in database 118. In this regard, various users or client computing devices may require the necessary security credentials (e.g., username, password, fingerprint, facial recognition, iris identification, etc.) to access information contained in control server 102. Alternatively, as long as a particular computing device is used to communicate with control server 102, a user may thereby be given access. As another alternative, any user may have access to data within control server 102.

User 202 of control server 102 may select which client computing devices 150-154 or users 250-254 have access to various information on database 118. In this regard, user 202 may be considered an administrator. As one example, administrator 202 may give access to particular surveys to client computing devices 150 and 153, but not computing devices 151, 152, and 154. Alternatively or in addition, administrator 202 may decide who gets access based on the particular user as opposed to the computing device. For example, administrator 202 may decide to give access to users 250 and 253, but not users 251, 252, and 254, in which case the identification associated with each user determines what information the user has access to. Ultimately, accessibility by users 250-254 and client computing devices 150-154 to control server 102 may depend on the preferences of administrator 202. It should be understood that control server 102 may be accessible by administrator 202 by using a separate computing device, such as a personal computer, laptop, tablet, Smartphone, etc., so long as administrator 202 has the necessary security credentials to be granted access to the administrator's clearance level, such as username, password, fingerprint, facial features, iris identification, etc.

As a further example, administrator 202 may create levels of authorization and access to various users of the system, which may also be stored in security/access information 128 of database 118. For instance, administrator 202 may give user 250 the ability to create new surveys and have the created survey stored in database 118. In this regard, user 250 is a second tier administrator and user 202 is a first tier administrator. Second tier administrators, like user 250, may have authorization to select what computing devices can access various surveys or not. The extent of the ability of user 250 to give access to other users in accessing database 118 may depend on the amount of security clearance control administrator 202 gives to user 250. For instance, user 250 may be able to create surveys only, give access to surveys only, or any combination thereof. Additionally, user 250 may be able to only give access to surveys that user 250 created, and user 250 may not be able give access or view any other surveys stored on database 118 without the authorization from administrator 202.

As a further example and as a security measure, various types of users will receive various levels of permission to view, copy or edit the data, depending on their need. For example, data collected at a health facility will only be visible to the assigned person from that health facility. For the project manager that oversees several health facilities, data will be cumulated from all health facilities within his/her jurisdiction or group, in which case the health manager may view all of the necessary data and information as well.

Furthermore, administrator 202 may provide full access to all of the public or select individuals or groups of the public to upload information to control server 102. For example, the public at large may be able input and upload information to control server 102, such that there are no restricts as to who can upload the information. As a further example, only select groups of people may upload information, such as a group of people in a certain geographic location. As another example, specific companies may be granted access to a portion of control server 102 such that the specific companies that are tasked with a particular job can upload the requisite information. For instance, if one particular company is designated as collecting data for a particular outbreak, such as Ebola, then that company may be able to upload information as it pertains to Ebola. Additionally, that same company may not be authorized to upload information about other diseases, such as HIV, because they have not been authorized to do so.

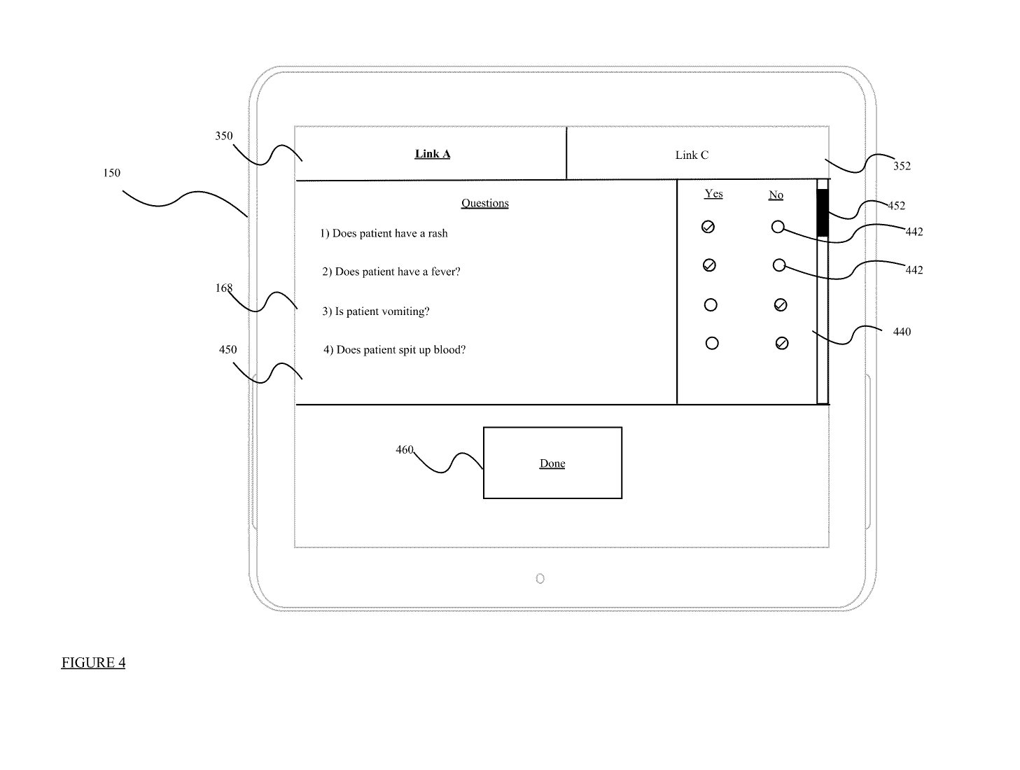

The survey may be associated with a link that directs end users, such as users 250-254, to a particular survey. For instance, as shown in FIG. 3, links 350-354 have been generated by control server 102 and made available to client computing devices 150-154. The links may be a Uniform Resource Locator (“URL”) that identifies the location of a particular survey, thereby allowing users to view, edit, download, etc. the survey. The URL may include a protocol identifier and resource name.

Links 350-354 may have been sent via e-mail, text message, or made available on a website operated by control server 102 and accessible by client computing devices 150-154 or users 250-254. In addition, links 350-354 may have been sent to each or only a selection of the computing devices 150-154. For instance, link 350 may have only been sent to client computing device 150 or alternatively link 350 may have been sent to each client computing device 150-154.

When user 250 selects link 350, the survey associated with link 350 is displayed on display 168. As discussed above, each survey may be made available to all or some client computing devices 150-154 or users 250-254. For instance, client computing device 153 or the user associated therewith may not have access to link 352. In this regard, if client computing device 153 or user 253 selects link 352, the user may be denied access and therefore not able to view the contents (e.g., survey) associated with link 352.

FIG. 3 illustrates an example of various computing devices or users having access to the created links. For instance, user 250 has the ability to access links 350 and 354; client computing device 151 has access to link 354; client computing device 152 has access to links 353 and 354; client computing device 153 has access to link 151; and client computing device 154 has access to link 353. As discussed above, the various computing devices may have access as a result of the administrator, or the users operating the computing devices may have access to the links upon having the proper security credentials.

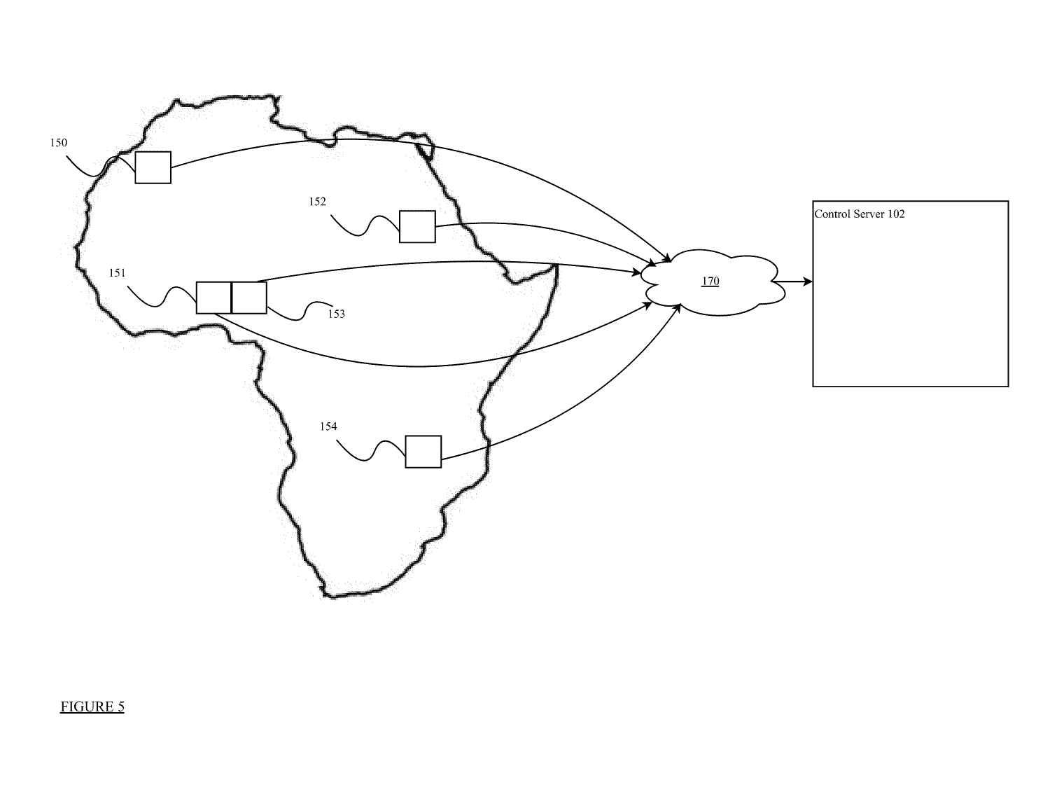

FIG. 4 illustrates computing device 150 displaying at least a portion of the survey associated with link 350 on display 168. As illustrated at a top portion of the display, Link A 350 and Link C 352 are shown at the top portion of display 168 as potential links that user 250 has access to. Link A 350 is bolded and underlined to illustrate that the current survey is associated with Link A 350. FIG. 4 further includes a question area 450 on display 168, where user 250 may be provided with questions associated with the survey associated with link 350. Adjacent to question area 450 may be answer area 440 that includes radio buttons 442. Although radio buttons 442 are displayed, any input mechanism may be used, such as checkboxes, text boxes to type in open ended answers, etc. There may further be a mechanism to upload attachments, such as photographs captured by camera 167, Microsoft® Word or other word processing software, PDF documents, geographic location information, etc. In this regard, a user may type up their own observations about a particular patient or series of patients in a word document processor or within the survey, if applicable. As another example, each client computing device may be tagged with a particular geographic location so that control server 102 is able to identify the specific location that the data came from, such as by using GPS 169.

As illustrated in question area 450 of FIG. 4, the developed questions may have been tailored to determine the presence, if any, of a particular disease, sickness, or symptom. Here, the questions have been tailored, by way of example only, to identify typical symptoms associated with Ebola. For instance, as shown in FIG. 4 questions include whether or not the patient has a rash or fever, whether the patient is vomiting, and whether or not the victim is spitting up blood. Scroll bar 452 allows user 250 to scroll down to answer any and all questions that are available for this particular survey. Any survey created is not limited to any particular number of questions. Furthermore, the created survey may include open-ended questions that allows the user, such as user 250, to type in answers themselves instead of checking or selecting a box or radio button. When the user is finished, the user may simply select Done button 460.

When the user is done inputting all relevant data about a particular patient, data inputted by user 250, such as the data associated with answer area 440, may be transmitted over network 170 to control server 102. Data may be transmitted immediately, that is, in real-time, after the user has completed their assessment of an individual patient, such as after the user selects Done button 460. Real-time transmittal of the data may occur in 0.2 second or less, for example. In this regard, control server 102 may be comprised of multiple servers arranged all over the world to provide quicker receipt of such data, such as using cloud based expandable storage. Alternatively or additionally, the data may be transmitted in batches, such as every 5, 10, 20, or any number of patients. When the data is transmitted may depend on the overall system or the preference of the administrator, although real-time transmittal of the data permits the real-time analyses of the data as discussed below.

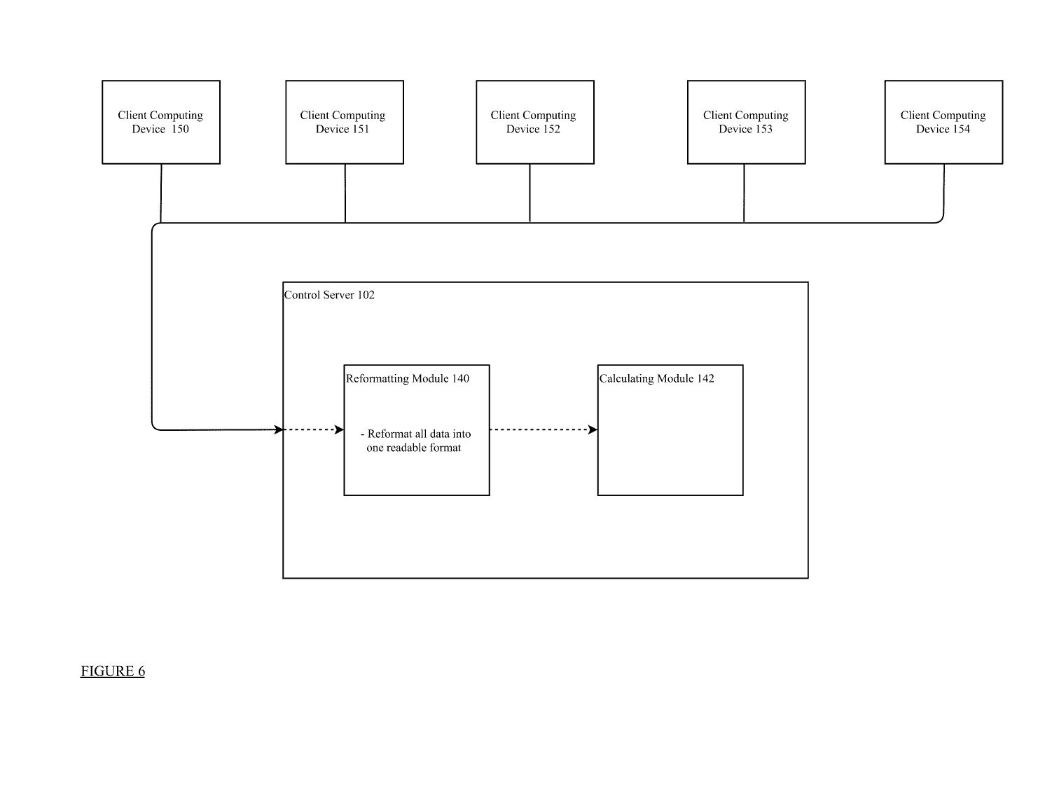

As illustrated in FIG. 5, client computing devices 150-154 are dispersed all throughout Africa, and the inputted data is transmitted via network 170 to control server 102. The data transmitted by each client computing device 150-154 may be data associated with the same or different surveys. For instance, as discussed with respect to FIG. 3, each user or client computing device may have access to particular surveys that other users or client computing devices may or may not have access to. The surveys that the various users or client computing devices have access to may depend on the access given by administrator 202. Further, the surveys each user or client computing device has access to may depend on the need in the given geographical region. For instance, in one geographical region there may be monitoring of HIV/AIDS, and in another geographical area there may be a monitoring of Ebola. Thus, the users monitoring for Ebola have no use for the HIV/AIDS survey, and the user monitoring HIV/AIDS has no use for the Ebola survey. As discussed above, however, which client computing device and survey depends on administrator 202, who may decide to grant complete access to all users and devices. For instance, administrator 202 may want all users to have access to all surveys in order to fully monitor all geographical regions.

Although only five (5) client computing devices are depicted in FIG. 5, a plurality of client computing devices may be positioned and located at each geographic location. For instance, the indication of client computing device 152 may actually represent 5, 10, 20, or any number of computing devices. In this regard, one displayed computing device on the map of FIG. 5 may represent, for example, five (5) client computing devices. In this regard, client computing devices 151 and 153 are positioned at a similar location, which may indicate that there are ten total client computing devices inputting data at that location.

Additionally, although FIG. 5 depicts Africa, it should be understood that the disclosure herein is not restricted thereto, but may be used for any country or geographic location, including the United States, any State within the European Union, Asia, etc.

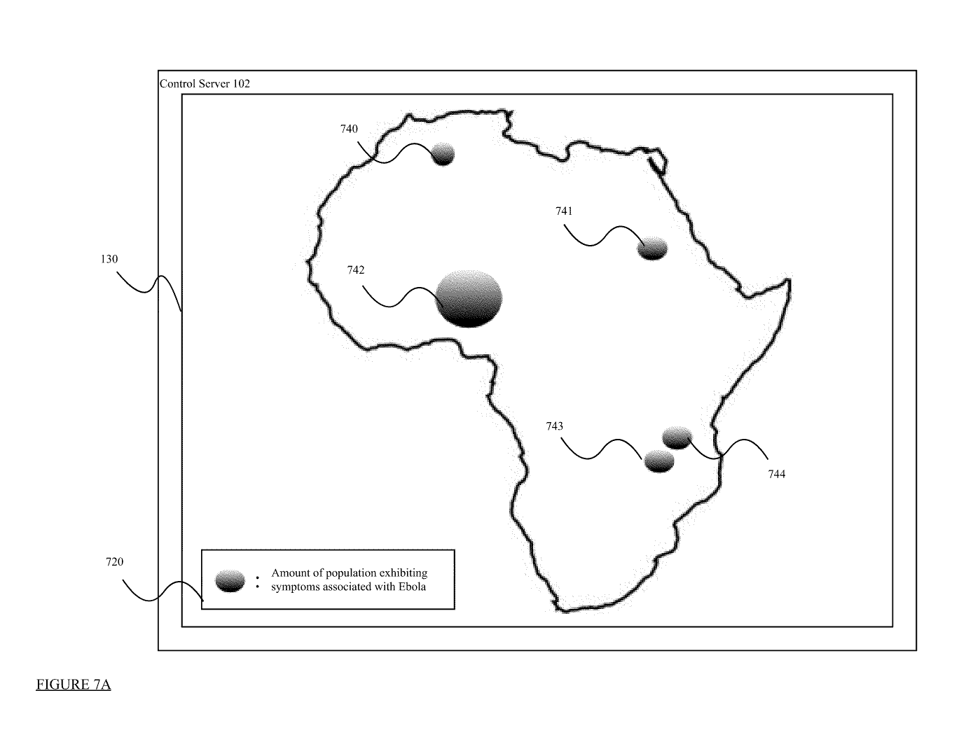

FIG. 6 further illustrates the transmission of data of FIG. 5 and the processing of data by control server 102. Here, control server 102 receives the various data from client computing devices 150-154. As illustrated in FIG. 5, reformatting module 140 first processes the received data. Data may be sent by various client computing devices in different formats, such as Excel®, Word, PDF, or other proprietary software of the particular client computing device. In this regard, in order for control server 102 to accurately and effectively monitor all information, reformatting module 140, in communication with processor 110, reformats all of the individual formats of the data into one readable format. The readable format may be proprietary to control server 102, or it may be in any type of format, including Excel, MySQL®, etc.

Once reformatting module 140 reformats the data into one readable and usable format, the data may be transmitted to calculation module 142. Calculation module 142, in communication with processor 110, may perform various calculations and transformations of the received data. For instance, all received data for each particular patient may be analyzed to determine which patients have Ebola and which patients do not have Ebola. What stage of the Ebola or any disease each individual patient is at may be determined as well, such as if the user is at early, middle, or late stages of the disease. Alternatively, if diseases have medically determined stages, such as stages 1-4, then each patient may be broken into one of the stages.

The processing of the data by calculation module 142 may automatically and in real-time display the results to the user, such as administrator 202. The data can be displayed in a way that describes the results (data summaries such as averages or proportions as appropriate), and graphically presented as either line graphs, trend charts, bar graphs, bubble graphs, time series, or any other type of visualizations currently possible using d3.js technology, Google® graphs, proprietary software, etc. The data may be compared from two groups (bivariate), or many groups (multivariate), in real time.

Below is a table of potential formulas that may be implemented by calculation module 140 in communication with processor 110, in real-time:

As referenced in the table above, calculation module 142 may predict the occurrence of what is to occur based on the received data. For instance, after analyzing the data, the calculation module may determine that a particular disease, such as influenza or Ebola, is going to continue expeditiously spreading in certain areas, and perhaps contract in other areas. This information may be helpful so that Non-Governmental Organizations know which areas to focus their efforts on in terms of dispersing medical supplies, personnel, food, and other care. For instance, if certain regions are already handling the particular outbreak well (e.g., reducing it's spread), then that area will not receive as much aid as areas that are seeing rapid spread.

As one example of prediction, a Bayesian Belief Network (“BBN”) may be constructed to further (and more sophisticatedly) analyze relationships, dependencies, and interconnectedness between variables (diseases and exposure, symptoms and disease, etc.). By way of example only, if there are two diseases that a patient may potentially have based on his or her identified symptom, a priori probabilities for each disease could be constructed from existing data, and then the conditional probabilities could be used to provide a probability that each patient has a disease given the symptoms exhibited. Testing for the disease could be added to the BBN in some way, such as to provide disease probability. This is just one example of how survey data could be used to construct a BBN that is useful to predict disease spread epidemiologically.

As a further example or alternative, if data on the spread of disease is available, such as from a patient zero, that disease could potentially be tracked using a switching linear dynamical system (“SIDS”). This may be considered a Kalman tacking filter that indicates locations in a time series where the dynamic model changes. For example, if a population tends to have a number of patients that exhibit a certain symptom without the disease being present, the SLDS could indicate the likelihood that the disease has spread to that population based upon the number of cases that exhibit this symptom above what is expected for that population. This model may be updated in real time as additional data is continuously collected, transmitted, and processed.

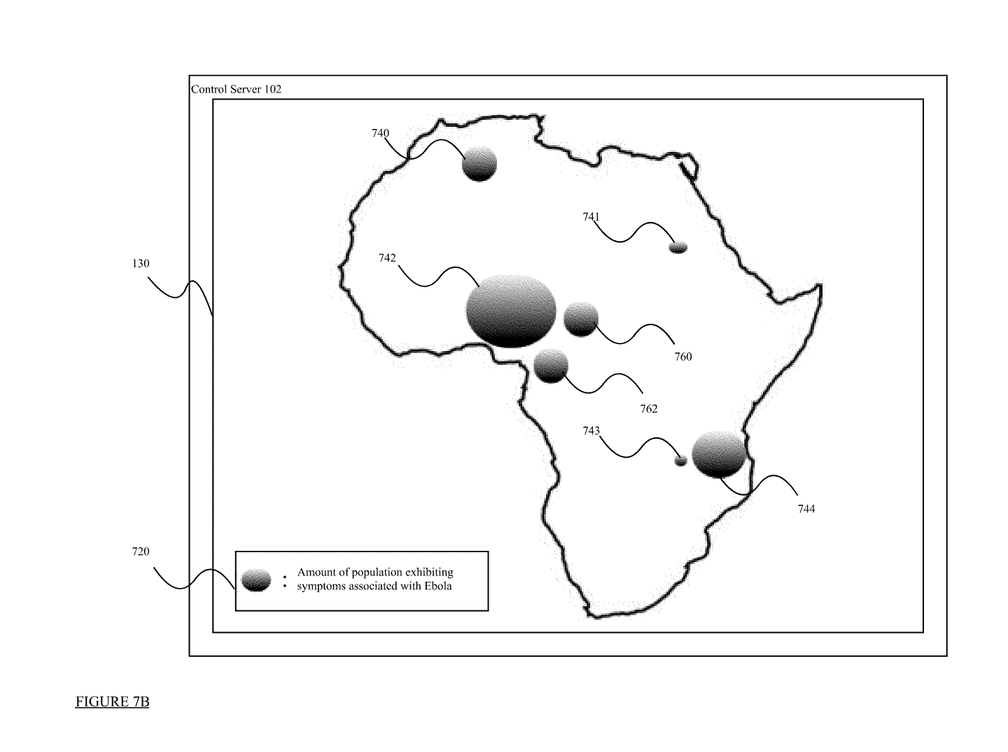

As an additional example, calculation module 142 may create a visualization of the received data on display 130. For instance, FIG. 7A illustrates various patches 740-744 that represent the presence of Ebola in the various regions at a first time period, and FIG. 7B illustrates various patches 740-744 that represent the presence of Ebola in the various regions at a second time period. The time between the first and second time periods of FIGS. 7A-B may be any amount of time, such as seconds, minutes, hours, days, weeks, months, years, etc. The amount of time may be set or customized by administrator 202 or any user that has been granted access to the data. For instance, if other individuals, such as a second tier administrator or one or more users 250-254 or client computing devices 150-154 have access to the visualization or collection of the data, then the particular user may set their own time period to see the progression or recession of the disease, in this case Ebola. In this regard, a user viewing the data may view the progression of the disease by selecting a particular starting date and time and a particular ending date and time. For instance, the user may select Jan. 1, 2015, at 12:00 a.m., as the start date and time, and then Dec. 31, 2016, at 11:59 p.m. as the ending date and time. Additionally or alternatively, the user may select a start date and time and then select a certain amount of time after the start date and time, such as a certain amount of seconds, minutes, hours, days, weeks, months, or years later.

Referring back to FIGS. 7A-B, FIG. 7B, which may be presented to administrator 202 on display 130, illustrates a sharp progression of Ebola at patch 740 and its surrounding region, namely patches 760 and 762. This may indicate a potential outbreak of Ebola in this region that would alert and prompt the population and various Non-Governmental Organizations to react accordingly. Further, FIG. 7B also illustrates the development of Ebola at patch 740, which may result in cause for concern. Conversely, FIG. 7B illustrates a reduction of Ebola at patches 741 and 743. The information regarding the reduction of an Ebola outbreak may be just as valuable as the information regarding the growth of the outbreak. For instance, when groups are aware of where a disease is reducing spread, resources do not have to be wasted on those areas as much as others. In addition, areas where growth of the disease is occurring may seek to learn from the systems and methods of the reduction sites, such as the handling and screening of Ebola patients. Finally, patch 744 illustrates a growth of the Ebola virus, which may indicate that the disease is spreading, that patients have been transferred to that region, both, or some other identifiable reason.

It should be understood that although the above examples reference Ebola as the subject disease, any symptom or disease may be tracked by the system and method discussed herein, such as influenza, HIV/AIDS, bubonic plague, Avian flu, Swine flu, etc.

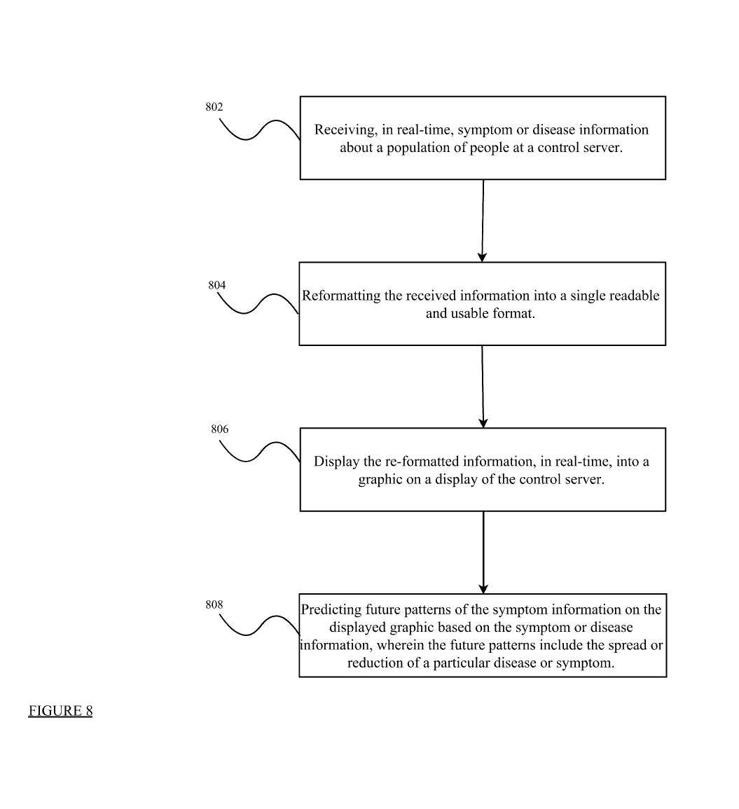

FIG. 8 illustrates a flowchart of one possible embodiment of the above disclosure. At step 802, a control server receives symptom or disease information about a population of people. The control server may receive the information from a plurality of users operating computing devices in the field, that is, on the ground at the geographic location. In that regard, the users may be considered data gatherers. At step 804, the control server re-formats the received data into one readable and usable data format. This may be, for example, into a MySQL® database. At step 806, the re-formatted information is processed and displayed into a visualization graphic on a display, in real-time. In this regard, real-time may signify that the data was received from a computing device, re-formatted, and processed and visualized in a fraction of a second or a couple of seconds, depending on the processing and amount of data. At step 808, the control server predicts the progression of the received symptom or disease information, such as a further spread or reduction of the spread of identified symptoms or disease.

As a further embodiment, the individual viewer who is viewing the data may customize the display and arrangement of the data on the computing device. For instance, display 130 may include a dashboard that administrator 202, or any viewer with authorization to the data (such as user 250 on display 168), can view the received data in real-time and customize to their preference. For instance, these dashboards can be individualized to the preferences of the user. For example, in a data collection tool with 20 questions, the user may be interested in tracking only 4 on their dashboard (for a quick status update). Data for all 20 questions will be available in the questionnaire report in real time, but users will be able to select those specific four to show up in the user's dashboard.

As a further embodiment, one or more of client computing devices 150-154 and control server 102 may communicate with each other via a proprietary correspondence application. For instance, the correspondence application may include a chat room or correspondence type forum to allow various users, such as users 202 and 250-254 to freely communicate with each other in real-time. The various users may want to communicate with each other to exchange information about identified symptoms, photographs of symptoms, and any necessary aid that may be needed at a particular location. Within the system, groups can be created and categorized. People can be invited to join the groups, and chat among each other in real time. They can upload documents, pictures, and video clips on the topic of discussion to share with others.

As an additional embodiment, data and information obtained by users 250-254 may still be collected and transmitted when there is a loss of electricity or other hazard. For instance, the data may be transmitted wirelessly using cellular towers, such as LTE, 4G, 3G, etc. technologies. This allows for the capture and processing of data during power outages or in impoverished areas that do not have a constant flow of electricity. Alternatively, the data may be stored locally in memory on the client computing devices, and then transmitted via WiFi once electricity is restored.

As a further embodiment, control server 102 may include a module configured to crawl and analyze the internet for information. For example, a web crawler may be implemented that indexes certain websites, searches for key words, analyzes and then stores the findings. For example, the web in general may be crawled or particular social networking sites, such as Twitter® to receive up-to-date information about a particular geographic location, outbreak, disease, etc. This information may be taken into consideration by the calculation model described above or by the system administrator when making various decisions. For example, the information obtained from the web crawler may be used to enhance geographic understanding of the spread of the disease as well as response by people to the disease.

Advantages of the present disclosure include the ability to bypass many of the usual problems with data, such as data inaccuracies, by making sure that users are collecting exactly what they are supposed to collect. In addition, data flow and access issues are resolved, such as time delay, because the data is accessible in real-time, e.g., instantaneously or essentially instantaneously, as the data is collected. Access issues are also resolved by having permission-based or level-based access (e.g., first tier administrators, second tier administrators, etc.). The system also promotes data use at the point of collection, which may be particularly important in poor and impoverished areas where the culture is to view reports as something needed for supervisors.

Another advantage of the present system is to eliminate data storage issues by utilizing expandable cloud based storage, which can continue to expand as necessary. In addition, multiple cloud based storage systems may be located all over a country or the world, thus allowing for quicker receipt, transmittal, and processing of the data (e.g., real-time processing), Furthermore, the present disclosure eliminates data analysis capacity issues, as analysis can be pre-programmed and executed in real-time, thereby avoiding the issue of attempting to develop a system that collects and analyzes data when the issue, e.g., epidemic, has already began. When the system is already developed and the desired information is already gathered, calculated, and determinations are performed, this makes it possible to gain insight from the data and generate knowledge, and to run programs based on locally derived and accurate evidence.

Based on the foregoing, the disclosure herein may provide a powerful tool in providing rapid information in case of an epidemic, such as Ebola, influenza, Swine flu, etc. The current disclosure also puts critical data, analyses, and visualization in real-time into the hands of Non-Govemmental Organizations in a user friendly manner that can allow the decision-makers to be efficient in terms of cost and time, and ultimately save lives or at the very least impact more lives worldwide.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “including” and the like) should not be interpreted as limiting the invention to the specific examples; rather, the examples are intended to illustrate only one of many possible embodiments.

1. A system, comprising:
memory; and
one or more processors operatively coupled to the memory, wherein the one or more processors are configured to:
continuously receive, from a plurality of computing devices, symptom information of a population, wherein the symptom information received from each of the plurality of computing devices is in a different data format;
reformat the received symptom information into a single data format;
display the reformatted symptom information in real-time into a graphic;
continuously update the displayed graphic, in real-time, with newly received symptom information of the population; and
predict future patterns on the displayed graphic based on the newly received transmitted information and the populous information, wherein the prediction of future patterns includes predicting future symptoms or diseases in a geographic region.

2. The system of claim 1, wherein at least two of the plurality of computing devices are in different geographical regions.

3. The system of claim 1, wherein the one or more processors are further configured to:
create a link, wherein the link is associated with a unique survey; and
send the link to at least one computing device of the plurality of computing devices, wherein selection of the link directs the at least one computing device to the unique survey.

4. The system of claim 3, wherein the one or more processors are further configured to:
send, at the at least one computing device, the unique survey, wherein the unique survey is completed; and
receive, from the at least one computing device, the completed unique survey.

5. The system of claim 1, wherein the continuously updated symptom information is continuously updated on the displayed graphic, the continuously updated displayed graphic illustrating a speed of spread of a disease or symptom.

6. The system of claim 1, wherein the one or more processors are further configured to display customizable segments of time of the displayed graphic, wherein the customizable segments of time illustrate the continuously updated symptom information being updated in that particular segment of time.

7. A method, comprising:
continuously receiving, from a plurality of computing devices using one or more processors, symptom information of a population, wherein the symptom information received from each of the plurality of computing devices is in a different data format;
reformatting, using the one or more processors, the received symptom information into a single data format;
displaying, using the one or more processors, the reformatted symptom information in real-time into a graphic;
continuously updating, using the one or more processors, the displayed graphic, in real-time, with newly received symptom information of the population; and
predicting, using the one or more processors, future patterns on the displayed graphic based on the newly received transmitted information and the populous information, wherein the prediction of future patterns includes predicting future symptoms or diseases in a geographic region.

8. The method of claim 7, wherein at least two of the plurality of computing devices are in different geological regions.

9. The method of claim 7, further comprising:
creating, using the one or more processors, a link, wherein the link is associated with a unique survey; and
sending, using the one or more processors, the link to at least one computing device of the plurality of computing devices, wherein selection of the link directs the at least one computing device of the plurality of computing devices to the unique survey.

10. The method of claim 9, further comprising:
sending, at the at least one computing device using the one or more processors, the unique survey, wherein the unique survey is completed; and
receiving, from the at least one computing device using the one or more processors, the completed unique survey.

11. The method of claim 7, wherein the continuously updated symptom information is continuously updated on the displayed graphic, the continuously updated displayed graphic illustrating a speed of spread of a disease or symptom.

12. The method of claim 7, further comprising displaying customizable segments of time of the displayed graphic, wherein the customizable segments of time illustrate the continuously updated symptom information being updated in that particular segment of time.

13. A system, comprising:
a first computing device and a second computing device, wherein the first and second computing devices include:
memory; and
one or more processors operatively coupled to the memory, wherein the one or more processors are configured to:
input, at the first computing device, information about a population of people; and
transmit, at the first computing device, the information to the second computing device;
receive in real-time, at the second computing device, the transmitted information;
combine, at the second computing device, the transmitted information with a plurality of transmitted information from a plurality of computing devices, and create a populous information based on the combined transmitted information and the plurality of transmitted information;
display, at the second computing device, the populous information in real-time into a graphic; and
continuously update the graphic in real-time, at the second computing device, with newly received transmitted information from the plurality of computing devices.

14. The system of claim 13, wherein the one or more processors are further configured to:
predict, at the second computing device, future patterns on the graphic based on the newly received transmitted information and the populous information, wherein the prediction of future patterns includes predicting future spread or outbreak of a disease.
